(19) United States
(12) Patent Application Publication
(10) Pub. No.: US 2025/0003823 A1
(43) Pub. Date: Jan. 2, 2025

(54) UNBALANCE MEASURING DEVICE, PROCESSING DEVICE AND METHOD FOR PROCESSING A WORKPIECE

(71) Applicants: thyssenkrupp Dynamic Components GmbH, Ilsenburg (Harz) (DE); thyssenkrupp AG, Essen (DE)

(72) Inventors: Henning BRANDENBURGER, Schmatzfeld (DE); Sebastian KRAUSE, Magdeburg (DE); Jonas STREVE, Illsenburg OT Druebeck (DE)

(73) Assignees: thyssenkrupp Dynamic Components GmbH, Ilsenburg (Harz) (DE); thyssenkrupp AG, Essen (DE)

(21) Appl. No.: 18/292,834

(22) PCT Filed: Jul. 27, 2022
(86) PCT No.: PCT/EP2022/071127

§ 371 Date: Jan. 26, 2024

(30) Foreign Application Priority Data
Jul. 28, 2021 (DE) 10 2021 208 139.8

(51) Int. Cl. G01M 1/24; G01M 1/34

(52) U.S. Cl. CPC G01M 1/24; G01M 1/34

(57) ABSTRACT

An unbalance measuring device, includes two spaced-apart workpiece receiving devices for rotatably receiving a workpiece, the unbalance of which is to be measured, and at least one sensor for detecting a vibration of the workpiece during the rotation, wherein the workpiece receiving devices each have a connection device for the positionally fixed fastening, and a workpiece receptacle for the rotational receiving, of a workpiece portion, wherein a spring device is in each case arranged between the connection devices and the workpiece receptacles.

The present invention relates to an unbalance measuring device according to the preamble of claim 1, to a processing device according to the preamble of claim 12, to a method for processing and for balancing a workpiece according to the preamble of claim 16, to a workpiece according to the preamble of claim 19, and to a method for producing a reference surface on a workpiece according to the preamble of claim 26.

Processing devices for processing rotationally symmetrical workpieces are well known. Processing processes, in particular machining processes, such as grinding, turning, etc., on workpieces are carried out on such processing devices.

For example, rotors for electrical machines, in particular electric motors, can be processed on such processing devices.

A problem in the case of rotors for electric motors arises from the fact that the performance increases at increased speeds, but therefore the requirements regarding balance quality and running characteristics become more exacting.

For this purpose, for example, a method and a device for balancing a workpiece have been disclosed in DE 10 2017 125 889 A1. Here, in particular, a method for balancing a workpiece is proposed, in which the workpiece is rotated about an axis of rotation, the forces and/or moments and/or vibrations which arise due to an unbalance of the workpiece during the rotation of the workpiece are measured, and material is removed from the workpiece in order to reduce the unbalance, and said method is distinguished in particular by the fact that the material is removed from the rotating workpiece during the measuring or the workpiece is rotated continuously between the measuring and removal. Furthermore, here, a device for balancing a workpiece is proposed, with a clamping device for the workpiece and a rotary drive for rotating the workpiece about an axis of rotation, comprising at least one sensor for measuring forces and/or moments and/or vibrations due to an unbalance of the workpiece during the rotation of the workpiece and at least one processing means for removing material from the workpiece by the rotation of the workpiece, which device is distinguished in particular by the fact that the processing means can be controlled on the basis of the signals of the sensor in such a way that the material can be removed during the rotation of the workpiece in order to reduce the unbalance.

Although a usable unbalance measuring device is proposed here, there is nevertheless a need for improvement, in particular with regard to improving the measurement result or the measurability and improving the results.

According to the invention, this object is achieved by an unbalance measuring device having the characterizing features of claim 1. Owing to the fact that the workpiece receiving devices each have a connection device for the positionally fixed fastening, and a workpiece receptacle for the rotational receiving, of a workpiece portion, wherein a spring device is in each case arranged between the connection devices and the workpiece receptacles, the unbalance measuring device can be better adapted to the needs of an unbalance measurement since the workpiece receptacles can each participate in a vibration of the workpiece and, when the dynamic behavior of the spring device is known, the vibration behavior of the workpiece caused by the unbalance can be measured better.

Further advantageous refinements of the proposed invention can be found in particular in the features of the dependent claims. The subjects or features of the different claims can in principle be combined with one another as desired.

In one advantageous refinement of the invention, it can be provided that at least one sensor is attached to one of the workpiece receptacles, in particular, in that one sensor is attached to each of the workpiece receptacles. The workpiece receptacle ideally performs the same vibration as the rotating workpiece and is also arranged upstream of the spring device with regard to the vibration characteristic such that the vibrations of the workpiece can advantageously be detected at this point by means of a sensor, in particular acceleration sensor.

In a further advantageous refinement of the invention, it can be provided that the workpiece receptacles form a predetermined rotational axis of the workpiece to be received. The received workpiece rotates accordingly about the rotational axis.

In a further advantageous refinement of the invention, it can be provided that the workpiece receiving devices each form a vertical axis, wherein the vertical axes intersect the rotational axis and are preferably oriented at a right angle to the rotational axis.

In a further advantageous refinement of the invention, it can be provided that the spring device is designed such that the connection device and the workpiece receptacle can be displaced in relation to each other from a starting position, wherein the spring device is designed to move the workpiece receptacle into the starting position. This results, together with the workpiece, in a spring system which can be defined with regard to its dynamic behavior and from which the unbalance of the workpiece can be calculated. Accordingly, the appropriate measures for remedying, but at least for reducing the unbalance, can be derived therefrom.

In a further advantageous refinement of the invention, it can be provided that the spring device has a leaf spring as a spring element, which is connected on the one hand to the connection device and on the other hand to the workpiece receptacle. A leaf spring is a very easily definable spring-loaded unit. In addition, it is very simple in terms of design and is correspondingly low-maintenance.

In a further advantageous refinement of the invention, it can be provided that the workpiece receptacles can be displaced in a movement direction component perpendicular to the rotational axis and perpendicular to the vertical axis relative to the connection devices. A movement direction component means, for example, part of a superimposed movement which arises, for example, from the connection by the pivot arms, forcing the connection device strictly speaking onto a circular path.

In a further advantageous refinement of the invention, it can be provided that the spring device has two pivot arms, each pivot arm being hinged on the one hand to the connection device and on the other hand to the workpiece receptacle, wherein joint axes of the pivot arms are preferably arranged parallel to the rotational axis. However, the pivot arms provide a stable connection between the connection device and workpiece receptacle, for example in the axial direction. Nonetheless, an almost linear movement can be carried out transversely with respect to the rotational axis of the workpiece.

In a further advantageous refinement of the invention, it can be provided that the workpiece receptacle is designed as a roller stand and in particular comprises two rotatably mounted rollers, which between them form the receptacle for a portion of the workpiece, wherein the axis of rotation of the rollers is preferably aligned parallel to the rotational axis. The workpiece ends can be placed onto such a workpiece receptacle in a simple manner.

In a further advantageous refinement of the invention, it can be provided that the unbalance measuring device is equipped with a quick-acting closure for each of the workpiece receptacles. In principle, the workpiece lies in each case at the edges in the workpiece receptacle. The quick-acting closure can also prevent the workpiece from falling unintentionally out of the workpiece receptacle.

In a further advantageous refinement of the invention, it can be provided that the quick-acting closure comprises a pivotable bracket with a rotatable roller, wherein the pivot axis of the bracket and/or the axis of rotation of the roller is aligned in particular parallel to the rotational axis.

Another object of the present invention is to propose an improved processing device, in particular to propose a processing device which permits conventional processing of the workpiece and improved detection of the unbalance of the workpiece.

According to the invention, this object is achieved by a processing device having the characterizing features of claim 12. Owing to the fact that the processing device has an unbalance measuring device according to the invention, the measurement of the unbalance of the workpiece can be carried out in an advantageous manner.

This can make it possible for the processing receptacle to continue to absorb all of the forces resulting from the processing. Nevertheless, it is possible for the workpiece to be inserted into the unbalance measuring device and to be accelerated to a predetermined unbalance measuring speed by the driving means, which are in any case available, of the processing receptacle. The driving means can be completely separate from the workpiece, and therefore the workpiece can then rotate completely freely on the unbalance measuring device and, for example, can travel through an unbalance measuring speed range over a predetermined time window. In said time window, a very genuine measurement of the vibrations can accordingly be carried out and data can thus be gathered for the subsequent processing of the workpiece for remedying or at least reducing the unbalance. In this respect, the workpiece can subsequently be coupled again to the driving means and the unbalance processing can be carried out, for example, with the one or more processing means that are present in any case, or else processing means provided separately for this purpose.

Further advantageous refinements of the proposed invention can be found in particular in the features of the dependent claims. The subjects or features of the different claims can in principle be combined with one another as desired.

In an advantageous refinement of the invention, it can be provided that the processing device has a processing table.

In a further advantageous refinement of the invention, it can be provided that the vertical axes are aligned perpendicular to the processing table, wherein the movement direction of the workpiece receptacles or at least one component of the movement direction of the workpiece receptacles is aligned perpendicular to the vertical axes and the rotational axis.

In a further advantageous refinement of the invention, it can be provided that the holding means comprise an Oldham coupling or form-fitting elements.

Another object of the present invention is to propose an improved method for processing and for balancing a workpiece with a processing device according to the invention, in particular to propose a method which permits improved detection of the unbalance of the workpiece and cost-effective processing, in particular balancing, of the workpiece.

According to the invention, this object is achieved by a method for processing and for balancing a workpiece with the characterizing features of claim 16. It is provided according to the invention that at least the following method steps are carried out by means of the processing device according to the invention:
receiving the workpiece by the holding means and coupling the driving means to the workpiece;
processing the workpiece with the processing means;
inserting the workpiece into the unbalance measuring device by moving the holding means or the unbalance measuring device and accelerating the workpiece to the balancing speed using the driving means;
removing driving means and at least one holding means, in particular both holding means, from the workpiece;
measuring the unbalance of the workpiece by means of the sensor and transmitting the measurement results to a data processing device;
receiving the workpiece by the holding means and coupling the driving means to the workpiece;
unbalance processing of the workpiece on the basis of the calculations of the data processing device, preferably by the processing means.

This makes it possible for the processing receptacle to continue to absorb all of the forces resulting from the processing. Nevertheless, it is possible for the workpiece to be inserted into the unbalance measuring device and to be accelerated to a predetermined unbalance measuring speed by the driving means, which are in any case available, of the processing receptacle. The driving means and the holding means are then completely separate from the workpiece, and therefore the workpiece can then rotate completely freely on the unbalance measuring device and, for example, can travel through an unbalance measuring speed range over a predetermined time window. In said time window, a very genuine measurement of the vibrations can accordingly be carried out and data can thus be gathered for the subsequent processing of the workpiece for remedying or at least reducing the unbalance. In this respect, the workpiece can subsequently be coupled again to the holding means and the driving means and the unbalance processing can be carried out, for example, with the one or more processing means that are present in any case, or else processing means provided separately for this purpose.

Another object of the present invention is to propose an improved method for balancing a workpiece with an unbalance measuring device according to the invention, in particular to propose a method which permits improved detection of the unbalance of the workpiece.

According to the invention, this object is achieved by a method for balancing a workpiece having the characterizing features of claim 17. It is provided according to the invention that at least the following method steps are carried out by means of the unbalance measuring device according to the invention:
inserting the workpiece into the unbalance measuring device by means of the holding means and accelerating the workpiece to the balancing speed using the driving means;
removing driving means and at least one holding means, in particular both holding means, from the workpiece;
measuring the unbalance of the workpiece by means of the sensor and transmitting the measurement results to a data processing device;
receiving the workpiece by the holding means and coupling the driving means to the workpiece;
unbalance processing of the workpiece on the basis of the calculations of the data processing device, preferably by the processing means.

The aforementioned method for balancing a workpiece with an unbalance measuring device according to the invention describes the method to a certain extent using only the unbalance measuring device, but without the aid of the entire processing device.

According to a further embodiment, the invention comprises a method for processing and for balancing a workpiece with a processing device, comprising the following method steps:
receiving the workpiece by the holding means and coupling the driving means to the workpiece, producing a mounting set-up;
processing the workpiece with the processing means in the produced mounting set-up;
processing the bearing points on the shaft stub in the produced mounting set-up;
forming at least one reference surface in the produced mounting set-up, in particular the same mounting set-up as the processing of the bearing points, wherein
   the reference surface has an axial extent along the rotational axis of the workpiece, wherein
   the reference surface at least partially extends over the circumference of the workpiece, preferably is formed over the full circumference on the workpiece, wherein
   the reference surface is formed in a region of the workpiece that is not the bearing point, the seat of a laminated core or the seat of a pressure disk;
inserting the workpiece into an unbalance measuring device, in particular by feeding it through the holding means and/or feeding it to the unbalance measuring device and accelerating the workpiece to the balancing speed using the driving means;
removing the driving means and at least one holding means, preferably both holding means, from the workpiece;
measuring the unbalance of the workpiece by means of the sensor and transmitting the measurement results to a data processing device;
receiving the workpiece by the holding means and coupling the driving means to the workpiece;
unbalance processing of the workpiece on the basis of the calculations of the data processing device, preferably by the processing means starting from the reference surface.

For example, a repetition of the following method steps is also carried out:
measuring the unbalance of the workpiece by means of the sensor and transmitting the measurement results to a data processing device;
receiving the workpiece by the holding means and coupling the driving means to the workpiece;
unbalance processing of the workpiece on the basis of the calculations of the data processing device, preferably by the processing means starting from the reference surface.

The position of the reference surface N on the workpiece is determined before the processing, in particular ascertained with the aid of a computer program. The precisely formed reference surface N is then the reference surface for further processing of the workpiece, for example for the balancing of the workpiece. Starting from this known reference surface N, in particular with high coaxial accuracy with respect to the bearing point L, the material having to be removed from the workpiece for balancing purposes or for reducing the unbalance can be calculated more accurately and can ultimately also be removed more accurately. With the better determination of the material to be removed or with the more precise removal of the material, the balance quality or the balancing grade increases.

If the reference surface N is not formed, the position on the workpiece and the quantity of material actually removed during the processing are subject to strong fluctuations. For example, tolerances in the production process of the workpiece, such as kneading, welding, casting or else the components for the multi-part rotor shaft or else the joined rotor, are subject to certain tolerances and process fluctuations. For example, the manufacturing accuracy during the joining or the laminated core B per se and, if necessary, the pressure disks D can thus also have a significant influence on the unbalance of the rotor. The targeted removal of material on the workpiece W can then lead to corresponding fluctuations in the results when reducing the unbalance. This is where the idea of the reference surface N, which is arranged coaxially with respect to the bearing point L, comes into play, by means of which a more precise removal of material and thus balance quality can be achieved.

For example, a basis for the reference surface can be made in an upstream step or in the production of the workpiece. In a downstream step, an improved, in particular the correct and highly accurate reference surface can then be made in a mounting set-up with the processing of the bearing points.

Further features and advantages of the present invention will become apparent from the following description of preferred exemplary embodiments with reference to the accompanying drawings, in which:

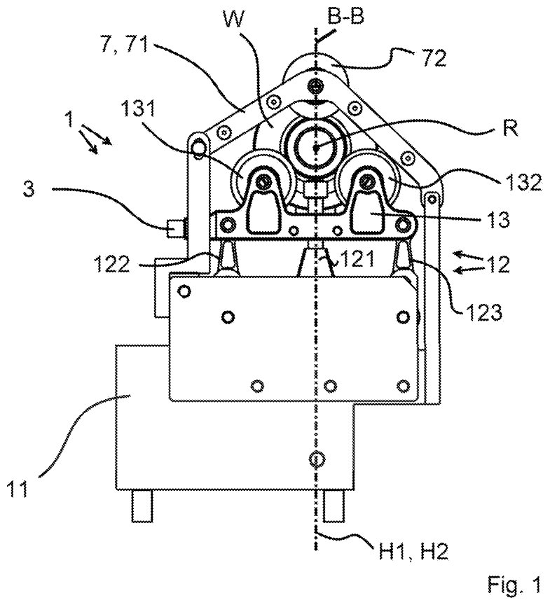

FIG. 1 shows an unbalance measuring device according to the invention in a lateral view;

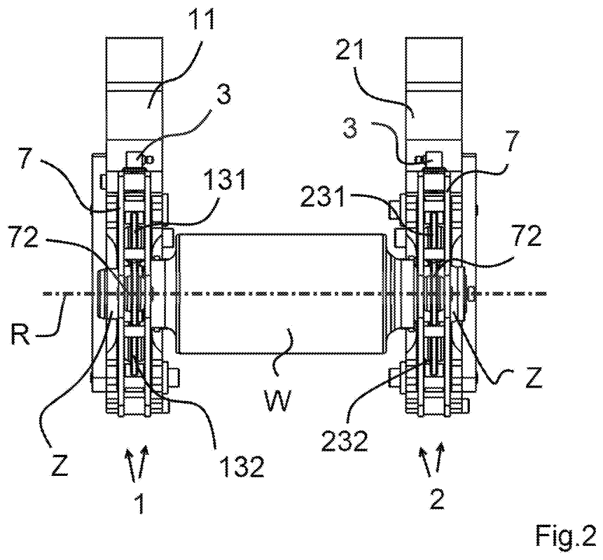

FIG. 2 shows an unbalance measuring device according to the invention in a view from above;

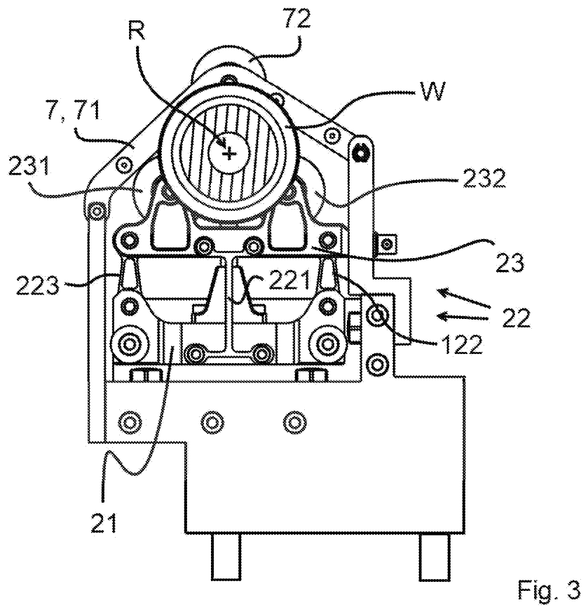

FIG. 3 shows a section A-A of an unbalance measuring device according to the invention;

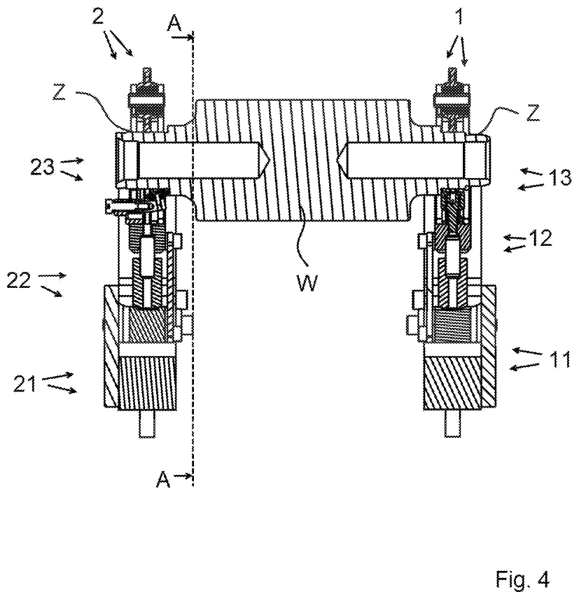

FIG. 4 shows a section B-B of an unbalance measuring device according to the invention;

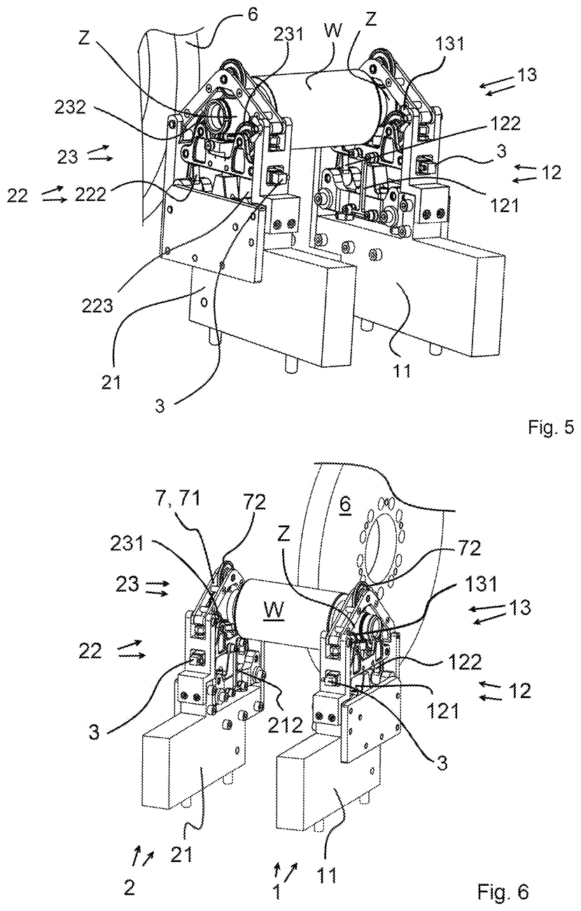

FIG. 5 shows a perspective illustration of an unbalance measuring device according to the invention;

FIG. 6 shows a perspective illustration of an unbalance measuring device according to the invention;

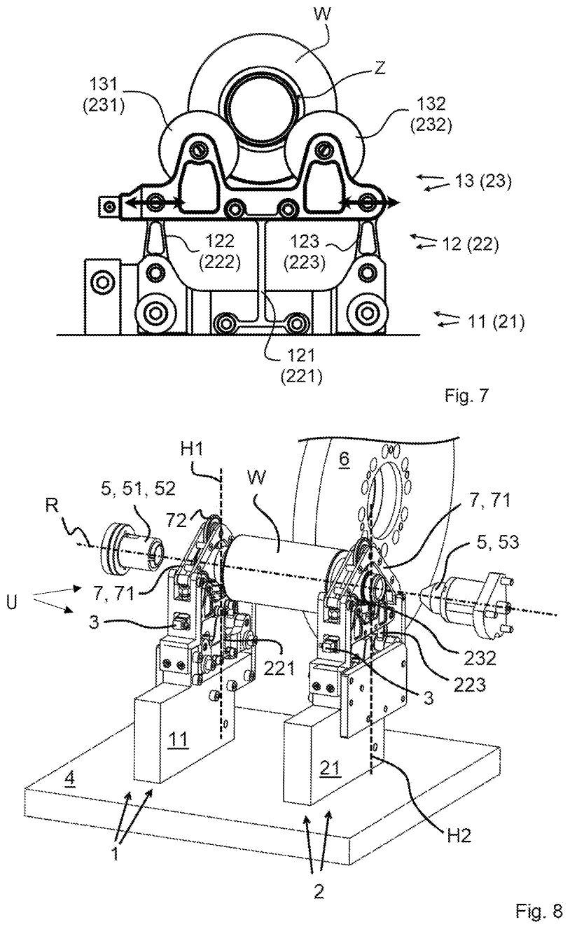

FIG. 7 shows an unbalance measuring device according to the invention in a lateral view with an indication of a movement direction;

FIG. 8 shows a processing device according to the invention in a schematic illustration;

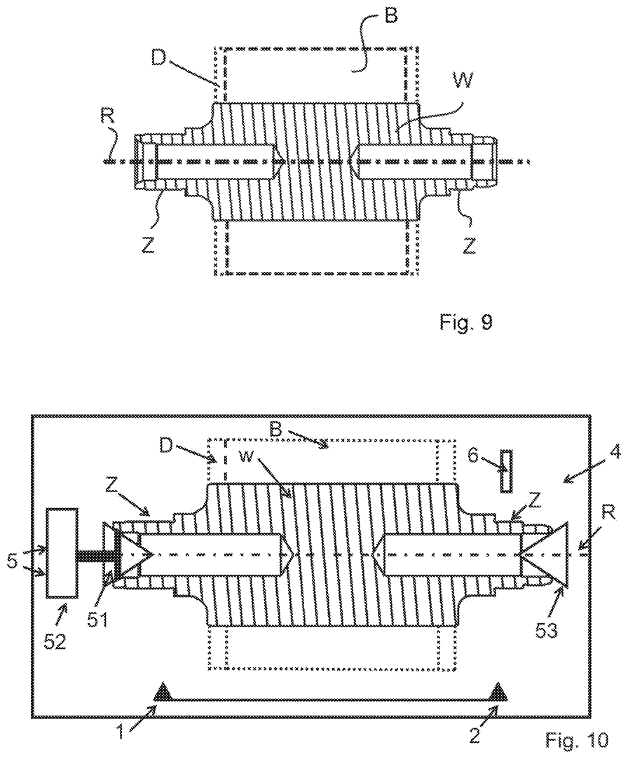

FIG. 9 shows an example of a workpiece, in particular a rotor shaft of an electric machine;

FIG. 10 shows a method step I of a method according to the invention in a schematic diagram;

FIG. 11 shows a method step II of a method according to the invention in a schematic diagram;

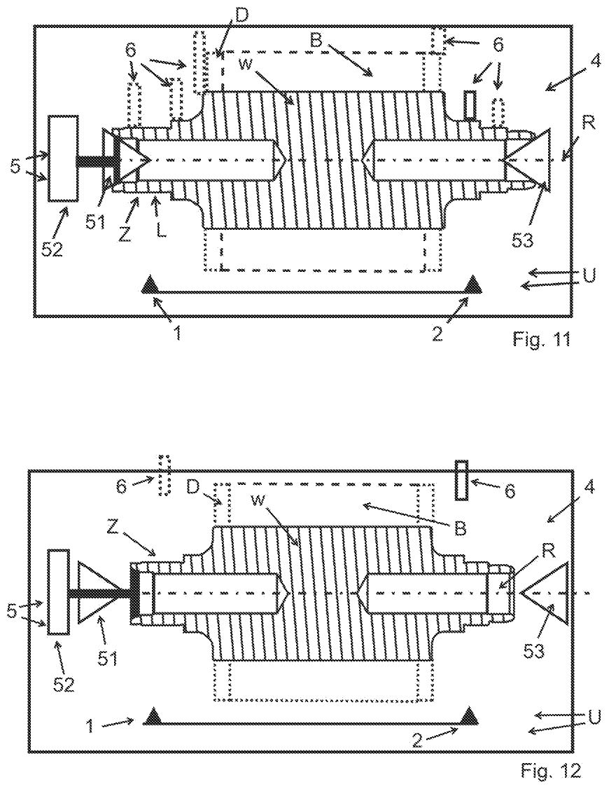

FIG. 12 shows a method step III of a method according to the invention in a schematic diagram;

FIG. 13 shows a method step IV of a method according to the invention in a schematic diagram;

FIG. 13a shows an alternative method step IV of a method according to the invention in a schematic diagram;

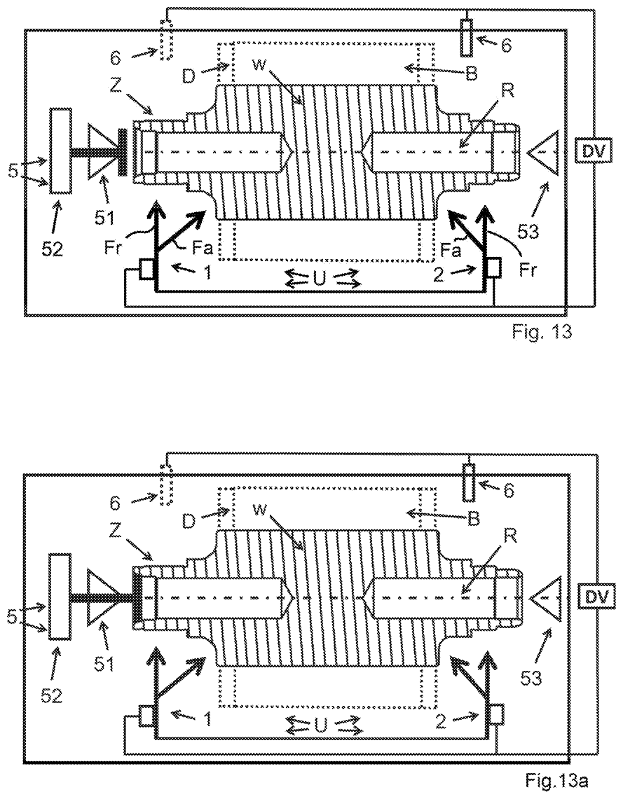

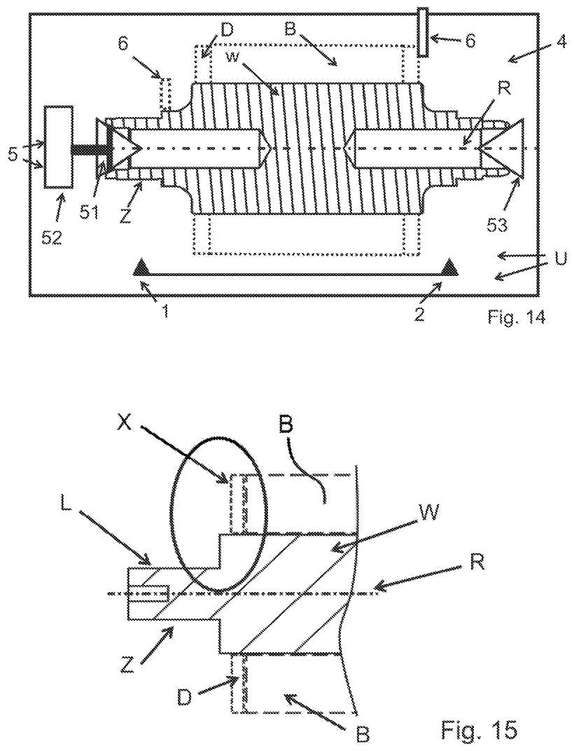

FIG. 14 shows a method step V of a method according to the invention in a schematic diagram;

FIG. 15 shows a view of a workpiece before the processing in a processing device according to the invention;

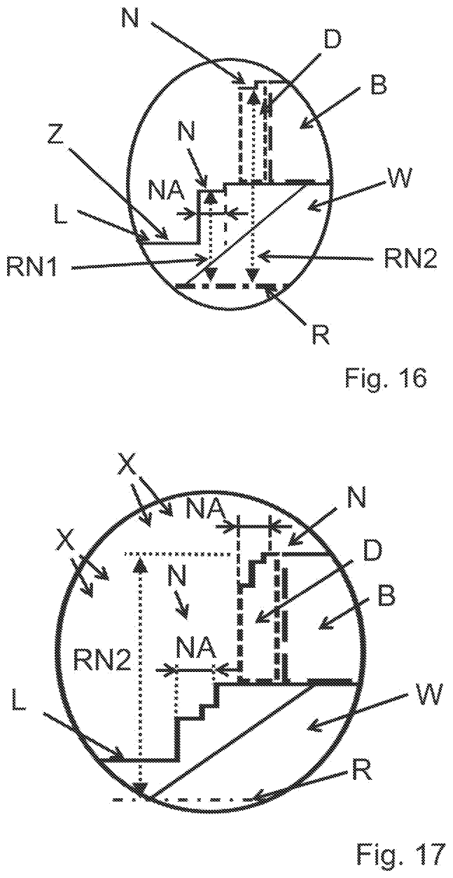

FIG. 16 shows a detailed view of a workpiece during the processing in a processing device according to the invention;

FIG. 17 shows a detailed view of a workpiece during the processing in a processing device according to the invention;

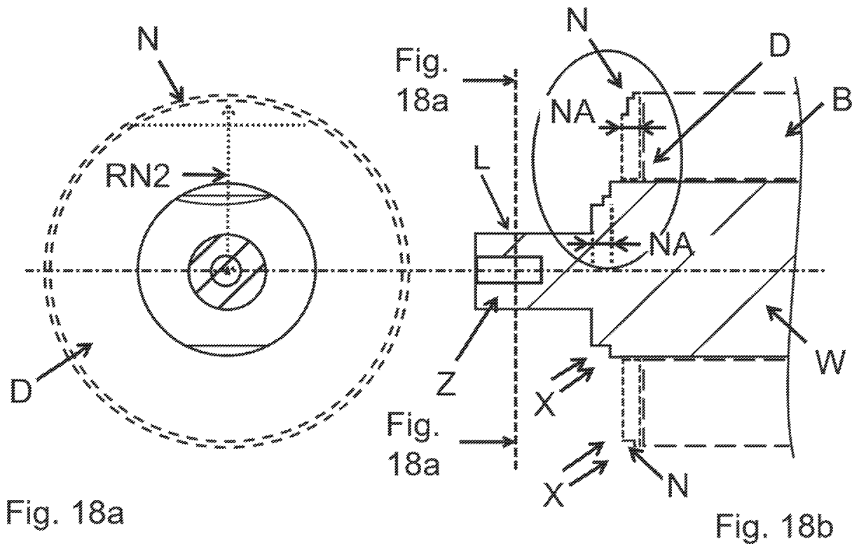

FIG. 18a shows a side view of a processed workpiece;

FIG. 18b shows part of a cross-sectional illustration through a workpiece processed in the processing device according to the invention;

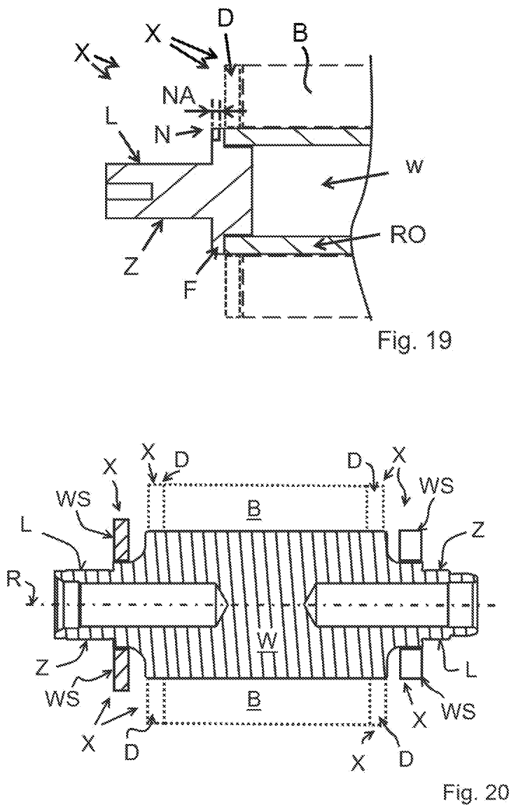

FIG. 19 shows a detailed view of a workpiece in one refinement;

FIG. 20 shows an example of a workpiece, in particular a rotor shaft of an electric machine;

FIG. 21 shows details of a further preferred refinement of a workpiece W;

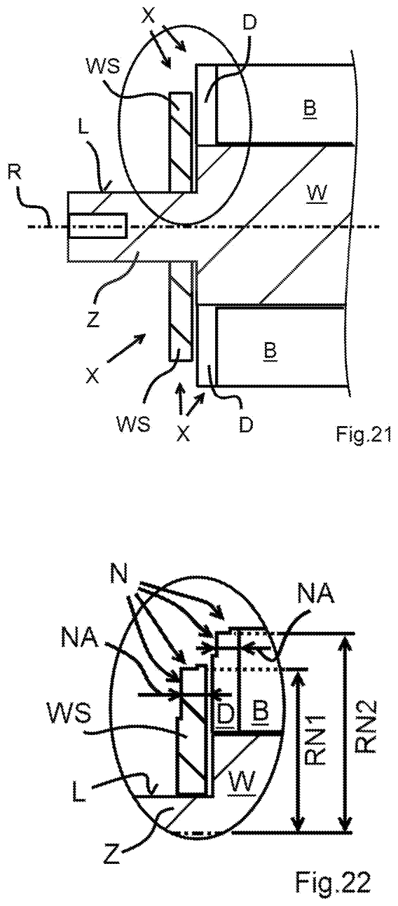

FIG. 22 shows in detail the section of the workpiece part W indicated by an oval ring in FIG. 21;

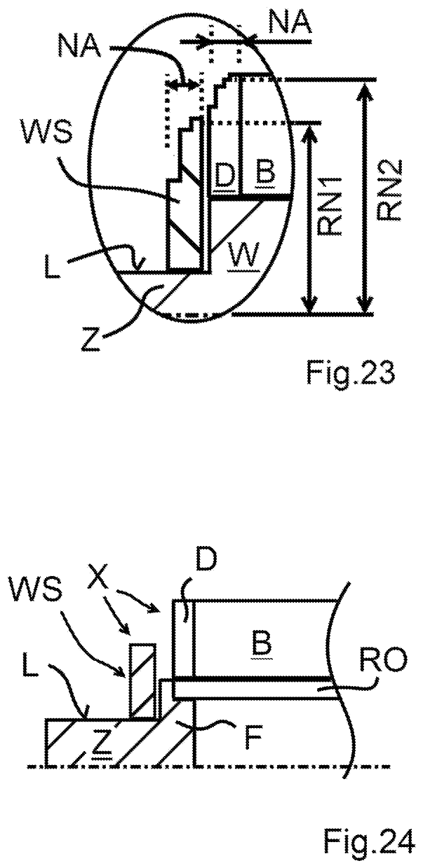

FIG. 23 shows the detail according to FIG. 22, the situation here being shown after the processing of the workpiece W;

FIG. 24 shows a preferred refinement of the workpiece W, wherein the workpiece W is designed, for example, as an assembled rotor;

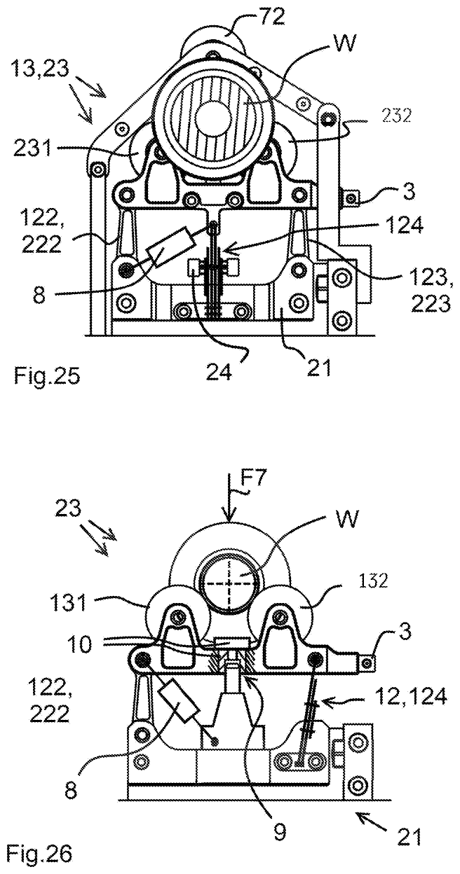

FIG. 25 shows, for example, an unbalance measuring device U, in which a refinement of the leaf spring 121, the leaf spring arrangement 124, is shown;

FIG. 26 shows another device in which various refinements are illustrated together;

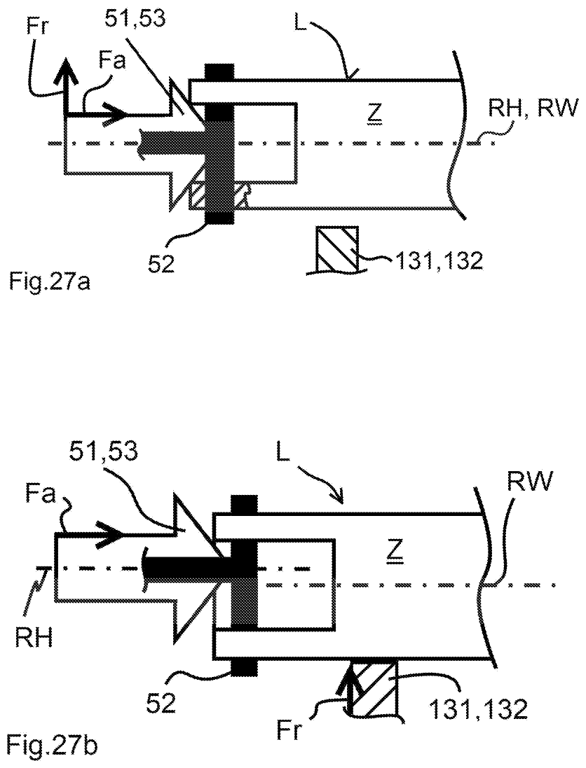

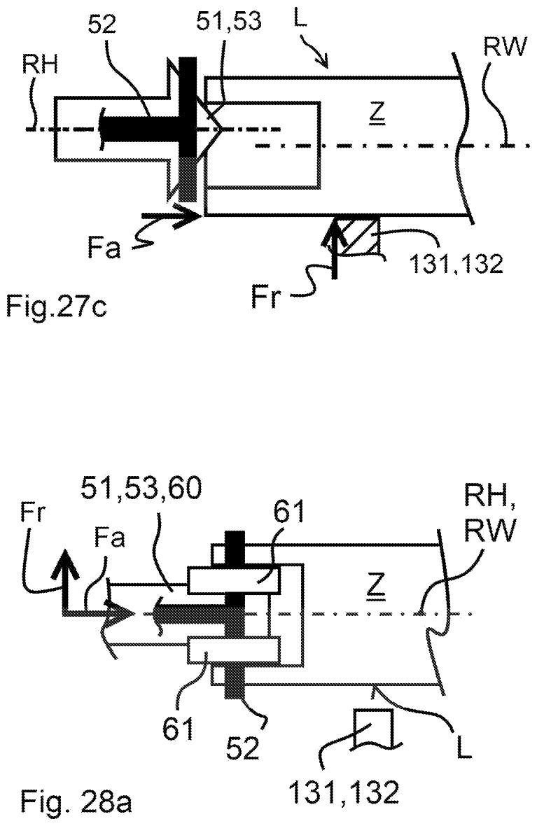

FIGS. 27a, b show schematically the shaft stub Z of workpiece W with the holding device;

FIG. 27c shows in principle, like FIG. 27b, the parallel-displaced course of the rotational axes RH, RW of holding means and workpiece;

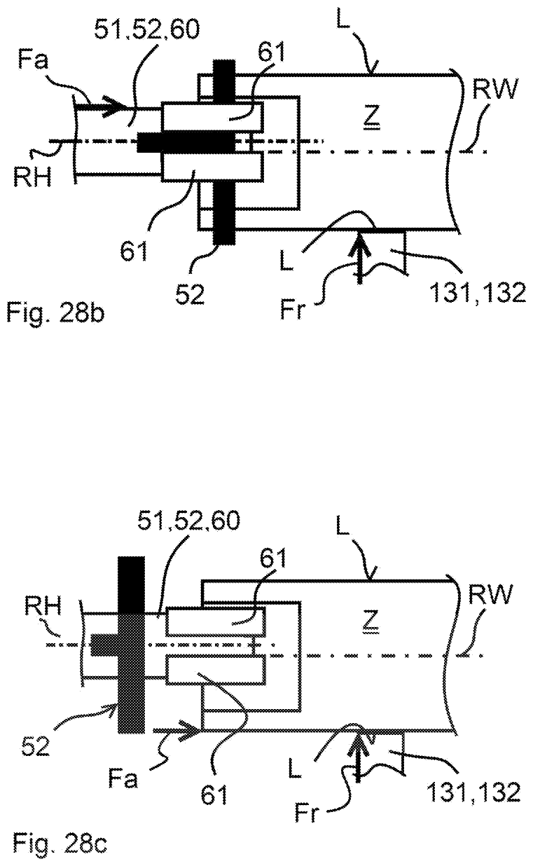

FIGS. 28a-c show schematically the shaft stubs Z of workpiece W through the holding device.

The following reference signs are used in the figures:
U unbalance measuring device
R rotational axis
H1 vertical axis
H2 vertical axis
W workpiece, in particular rotor shaft
Z shaft stub
B laminated core
D pressure disk
DV data processing device
L bearing point
N reference surface
NA axial extent of the reference surface
F flange
F7 force
Ro tube
RN1 radius/distance of the reference surface from the rotational axis R
RN2 radius/distance of the reference surface from the rotational axis R
RH rotational axis of holding means
RW rotational axis of workpiece
WS balancing disk
X region on the workpiece W at which the reference surface N is intended to be formed
1 first workpiece receiving device
2 second workpiece receiving device
3 sensor, in particular acceleration sensor
4 processing table
5 processing receptacle
6 processing means
7 quick-acting closure
8 damper
9 stop
10 adjustment of the stop 9
11 connection device
12 spring device
13 workpiece receptacle
21 connection device
22 spring device
23 workpiece receptacle
24 adjustment of the spring device
51 first holding means
52 driving means
53 second holding means
60 spreadable holding means
61 clamping receptacle of the holding means 60
71 bracket
72 roller
121 leaf spring
122 pivot arm
123 pivot arm
124 leaf spring arrangement
131 first roller
132 second roller
221 leaf spring
222 pivot arm
223 pivot arm
231 first roller
232 second roller

Features and details that are described in conjunction with a method self-evidently also apply in conjunction with the device according to the invention and vice versa, such that reference is always or can always be made reciprocally with respect to the disclosure of the individual aspects of the invention. Moreover, a possibly described method according to the invention can be carried out by way of the device according to the invention.

The terminology used serves only for the purpose of description of particular embodiments, and is not intended to restrict the disclosure. As used herein, the singular forms “a/an” and “the” are also intended to include the plural forms unless the context clearly indicates otherwise. In addition, it will be clear that the terms “has” and/or “having”, when used in this description, specify the presence of the stated features, integers, steps, operations, elements and/or components, but do not rule out the presence or the addition of one or more other features, integers, steps, operations, elements, components and/or groups thereof. As used herein, the term “and/or” includes any desired element and all combinations of one or more of the associated, listed elements.

First of all, reference is made to FIG. 1.

An unbalance measuring device U according to the invention comprises a first workpiece receiving device 1, a second workpiece receiving device 2 and a sensor 3 for determining an unbalance of a rotating workpiece W.

The first workpiece receiving device 1 comprises a connection device 11 for the releasable connection to a processing table 4. In addition, the first workpiece receiving device 1 comprises a workpiece receptacle 13. The workpiece receptacle 13 is designed for rotatingly receiving a portion of the workpiece W.

The second workpiece receiving device 2 comprises a connection device 21 for the releasable connection to the processing table 4. In addition, the second workpiece receiving device 2 comprises a workpiece receptacle 23. The workpiece receptacle 23 is designed for rotatingly receiving a portion of the workpiece W.

The workpiece receiving devices 1, 2 are arranged at a distance from each other such that a workpiece W can be arranged between the workpiece receiving devices. In this case, it is preferably provided that the ends of the workpiece, in the example given here, the shaft stubs Z of a rotor shaft, are received in the workpiece receptacles 13, 23 in each case. In this respect, the workpiece receptacles 13, 23 and the received workpiece W form a rotational axis R. The workpiece W can thus be received rotationally about the rotational axis R in the workpiece receptacles 13, 23 between the two workpiece receiving devices 1, 2. Preferably, by suitable selection of the distance, the workpiece receiving devices 1, 2 form an axial boundary, and therefore the workpiece W cannot be displaced or can be displaced only slightly between the workpiece receiving devices 1, 2.

In the figures, furthermore, a vertical axis H1 or H2 is in each case used for orientation, the vertical axis preferably running perpendicularly from the processing table 4 through the rotational axis R.

According to the invention, it is provided that a spring device 12 or 22 is arranged between the connection device 11 or 21 and the workpiece receptacle 13 or 23, which spring device is designed such that the workpiece receptacle 13 or 23 can be moved relative to the connection device 11 or 21 in a direction perpendicular or substantially perpendicular to the rotational axis R counter to the force of a spring 121 or 221.

The spring device 12 accordingly in principle permits a deviating movement, which is predetermined in terms of its direction, of the workpiece receptacle 13 or 23 and the positionally fixedly attached connection device 11 or 21. As a result, in principle, a vibration caused by an unbalance of a rotating workpiece W, which is received by the unbalance measuring device U, can be transmitted to the workpiece receptacles 13 and 23. However, the workpiece receptacles 13 and 23 are not fixedly connected to the connection devices 11 and 21, and therefore they can form a defined vibrating system together with the workpiece W. With knowledge of the dynamic properties of this system, the vibrations of the workpiece W that are actually of interest can be calculated by the vibrations of the entire system consisting of workpiece W and workpiece receptacles 13 and 23. For this purpose, it is provided that at least one workpiece receptacle, preferably both workpiece receptacles 13 and 23, are equipped with a corresponding sensor 3, in particular acceleration sensor, which sensors in turn are connected to a data processing device DV.

Preferably, the first workpiece receiving device 1 and/or the second workpiece receiving device 2 is equipped with a spring device 12, 22.

It is also preferably provided that the spring device 12 or 22 has a leaf spring 121 or 221. The leaf spring is preferably aligned in the direction of the vertical axis H1 or H2.

In the case of the unbalance measuring device U shown, the decoupling is preferably realized by means of a mechanical spring device 12 or 22. However, the corresponding spring effect can also be achieved by other measures, such as hydraulic or pneumatic components.

It is also preferably provided that the spring device comprises a first pivot arm 122 or 123 and a second pivot arm 222 or 223 between the connection device 11 or 21 and the workpiece receptacle 13 or 23, wherein the pivot arms are arranged hingedly both on the connection device and on the workpiece receptacle. The joint axes of the pivot arms 122, 123 or 222, 223 are preferably arranged parallel to the rotational axis R. This arrangement results in a connection in the manner of a flat pivot joint transmission which is not capable of revolving. In this respect, the pivot arms 122, 123 or 222, 223 force the respective workpiece receptacle 13 or 23 onto an almost rectilinear, actually slightly circular, path of movement. However, the linear movement component is essential first and foremost. The spring 121 or 221 is arranged between the connection device 11 or 21 and the workpiece receptacle 13 or 23 in such a way that the workpiece receptacle 13 or 23 is always moved back to a central position, in which the pivot arms 122, 123 or 222, 223 are aligned perpendicular to the processing table or parallel to the vertical axis H1 or H2. The spring 121 or 221, in particular leaf spring, is preferably aligned congruently with the vertical axis, in particular parallel to the vertical axis H1 or H2. The approximate movement direction is shown by means of arrows in particular in FIG. 14.

It is also preferably provided that the workpiece receptacles 13 and 23 of the unbalance measuring device U in each case comprises a first rotatable roller 131 or 231 and a second rotatable roller 132 or 232, which form between them the receptacle for a portion of the workpiece W, for example, the shaft stubs of a rotor shaft. The axis of rotation of the rollers 131, 132, 231, 232 is preferably aligned parallel to the rotational axis R. It is correspondingly provided that the workpiece ends are received between the rollers 131 and 132 or 231 and 232, but the roller distance is smaller than the diameter of the workpiece end to be received. The received workpiece end can accordingly be supported by the two rollers.

It is also preferably provided that the unbalance measuring device U is equipped with two quick-acting closures 7. The quick-acting closure 7 essentially comprises a pivotable bracket 71. The bracket 71 has an L-shaped design. The pivot axis is aligned parallel to the rotational axis. In addition, the quick-acting closure comprises a rotatable roller 72. The axis of rotation of the roller is aligned parallel to the rotational axis. The workpiece is already held in the direction of gravity in the workpiece receptacles 13 and 23, in particular between the rollers 131, 132 or 231, 232. With the quick-acting closure 7, the receptacle can be closed to a certain extent by the roller 72 of the quick-acting closure 7 resting on the workpiece end from above. In this case, the workpiece end is surrounded by three rollers and accordingly can no longer escape. By pivoting or opening of the quick-acting closures 7, the receptacle can be released accordingly and the workpiece W removed. The actuation of the quick-acting closure 7 can be automated, in particular hydraulically or pneumatically.

A processing device according to the invention for a workpiece W essentially comprises a processing receptacle 5 for receiving the workpiece, comprising a first holding means 51, a second holding means 53 and a driving means 52, wherein the driving means 52 is designed to set the workpiece W into rotation, wherein the holding means 51, 53 are designed for holding the workpiece W. Furthermore, the processing device comprises at least one processing means 6 for processing the workpiece W, and an unbalance measuring device U according to the invention.

The processing means 6 may be, for example, a milling, turning or grinding device. Other devices for the processing, in particular machining, of, in particular metallic, workpieces are also conceivable. In particular, the direction of approach of the respectively selected processing means 6 to the workpiece W may vary depending on the selected processing means 6.

The processing receptacle 5 is preferably connected to the processing table 4 or attached thereto. For example, the processing table 4 is mounted in a fixed position. However, the processing table may also be movable in such a way that the unbalance measuring device U mounted on the processing table, in particular the workpiece receiving devices 1, 2, can be moved counter to the processing receptacle 5, in particular to the holding means 51, 53 or the workpiece. The unbalance measuring device U can thus also be fed to the workpiece and/or processing receptacle 5, in particular the holding means 51, 53 or the received workpiece can be fed to the unbalance measuring device U. For example, the processing table 4 can also be formed in multiple parts, in particular in such a way that a first part of the processing table 4 forms the holding means 51, 53 and the driving means 52 and a further part of the processing table 4 carries the unbalance measuring device U, in particular unbalance measuring machine.

Forces and torques can be dissipated in principle into the processing table 4. The processing receptacle 5 can be directly connected to the processing table. The workpiece receptacles 13 and 23 are indirectly connected to the processing table 4 via the spring devices 12 and 22, respectively.

The holding means 51, 53 are in principle designed to enter into a releasable, in particular quickly releasable, connection with the workpiece W. The holding means 51 are designed for holding purposes, in particular for holding purposes suitable for processing with the processing means 6. The holding means 51, 53 are connected to a transport mechanism (not shown here), with which, for example, transferring or positioning of a held workpiece, for example, placing it on or removing it from the unbalance measuring device U, in particular from the workpiece receiving devices 1, 2, can be undertaken.

Suitable holding means 51, 53 are, for example, Oldham couplings with corresponding cones or truncated cones, which can engage in, for example, hollow-cylindrical shaft ends of a workpiece, in particular a rotor shaft, or the holding means comprises aforementioned components. The holding means 51, 53 may also be corresponding form-fitting elements or the holding means comprises aforementioned components, which can produce a form-fitting connection releasably to the workpiece W, in particular to the shaft stubs Z, for example, according to the lock and key principle.

The driving means 52 can be, for example, an electric motor or else a stepper motor, with which the workpiece W can be set into rotation or with which a predetermined angular position of the workpiece W can be approached.

Further details of the present invention can be found in particular from an exemplary description of the method according to the invention.

The method according to the invention is to be explained below. It is understood that only a few selected method steps, as are helpful for understanding the method according to the invention, are shown here. The method may comprise further steps or intermediate steps known to a person skilled in the art.

A rotationally symmetrical workpiece W, such as a rotor shaft of an electric machine, is conceivable as a workpiece. Such a rotor shaft is shown, for example, in FIG. 9. In particular, the rotor shaft W with end-side journals Z, and the laminated core B, illustrated by dashed lines, and the pressure disks D, illustrated by dotted lines, are shown.

FIG. 10 schematically shows a rotor shaft W, which is received by the processing receptacle 5, in particular by the holding means 51, 53. The workpiece W is not yet inserted into the workpiece receiving devices 1, 2 of the unbalance measuring device U.

First of all, the workpiece is processed conventionally by the processing means, for example by grinding the workpiece or machining same in a process involving turning. However, this processing is used for general processing, rather than for balancing the workpiece W.

FIG. 11 schematically illustrates processing of the workpiece W, in particular the bearing points on the rotor shaft. For this purpose, the processing means 6, for example a grinding device, is used. A bezel or the like is also possible for absorbing and/or supporting grinding forces. A dashed line indicates a different processing situation or a different tool.

Preferably, the driving means 52 sets the workpiece W into rotation during this processing.

FIG. 12 schematically shows ground bearing points L of the workpiece W. It is also shown how the processing means 6 is no longer in use or has been moved away. The processed, at least partially processed, workpiece W has been moved to the workpiece receiving devices 1, 2 of the unbalance measuring device U by means of the processing receptacle, in particular the holding means 51, 53, and has been deposited on the workpiece receiving devices 1, 2, in particular the workpiece receptacles 13, 23. Alternatively or additionally, it can also be provided that the workpiece receiving devices 1, 2 of the unbalance measuring device U are brought toward the partially processed workpiece, i.e., the unbalance measuring device U is moved to the workpiece W. The holding means 51, 53 are separated from the workpiece W, alternatively only one holding means is separated from the workpiece W, preferably the holding means 53, which is arranged on the opposite side of the drive 52, is separated. However, the driving means 52 is connected to the workpiece W. In particular, radial and axial guiding of the workpiece W by the workpiece receiving devices 1, 2 is provided. For example, the workpiece W can be axially guided in the unbalance measuring device U by means of a spring-loaded element. In particular, this spring-loaded element loads and guides the workpiece W axially and engages, for example, on one edge of the workpiece W. The forces which the workpiece receiving devices 1, 2 exert on the workpiece are shown schematically by way of example in FIG. 13 by the thicker arrows, with in particular radial supporting forces Fr and axial guiding forces Fa being shown.

It can be provided that the workpiece is additionally secured against falling out by the quick-acting closure 7 on the workpiece receiving devices or the workpiece receptacles.

The driving means 52 brings the workpiece W to a speed, in particular to a balancing speed. A balancing speed should be understood here as meaning a speed of the workpiece W at which the unbalance is intended to be measured. This depends in particular on the component to be balanced and its subsequent operating speeds. For the angularly precise receiving of the workpiece W, the angular position of the workpiece W can preferably be determined via sensors and references formed/mounted on the workpiece W.

FIG. 13 schematically shows how the driving means 52 has been decoupled after reaching the balancing speed. The drive is still in engagement with the workpiece. This means that the workpiece W rotates freely in the unbalance measuring device U, in particular in the workpiece receptacles 13, 23. The decoupling of all of the machine parts, such as headstocks, bezels, tailstocks, tools, etc., is advantageous for the measuring process. Thus, it is preferably ensured that the measurement is not influenced by other rotating bodies and their masses or their vibration behavior. The receiving of the workpiece W on the workpiece receiving devices 1, 2 and the decoupling of the driving means 52 or the holding means 51 may overlap.

FIG. 13a schematically shows an alternative embodiment in which the workpiece W is still in engagement with the driving means 52, but the holding means 51, 52 have been disconnected or separated. This means that the workpiece W rotates freely in the unbalance measuring device U, in particular in the workpiece receptacles 13, 23, and can nevertheless be kept at the desired speed or brought to the desired speeds. The driving means 52 is advantageously in engagement with the workpiece W by means of an Oldham coupling, as a result of which the driving influences on the workpiece W can be minimized. The decoupling of the machine parts, such as headstocks, bezels, tailstocks, tools, etc., is advantageous for the measuring process. Thus, it is preferably ensured that the measurement is not influenced by other rotating bodies and their masses or their vibration behavior. The receiving of the workpiece W on the workpiece receiving devices 1, 2 and the decoupling of the driving means 52 or the holding means 51 may overlap.

The workpiece W rotates at the desired speed, in particular the balancing speed. The unbalance is measured using the sensor 3 or the sensors 3. During the measurement, the speed can drop or run through a predetermined speed range. The measurement results are transmitted to the data processing device DV. The data processing device DV calculates the measures for eliminating or at least reducing the unbalance to a technically acceptable level. The data processing device DV subsequently then also controls the processing means 6.

FIG. 14 schematically shows how the measures calculated by the data processing device DV are carried out, in particular how material at predetermined points of the workpiece W is removed. Preferably, these predetermined points are highly accurate, in particular have a low concentricity error on reference surfaces N formed relative to the bearing point L. For this purpose, the same processing means 6 as for the conventional processing, and a separate processing means can be used. Furthermore, it is preferably provided that the workpiece W of the unbalance measuring device U is removed again, in particular by the holding means 51. It may also be provided that the workpiece W is now coupled again to the driving means 52 and thereby is set into rotation or predetermined angular positions are approached. If the quick-acting closure 7 has been used previously, it has been opened again beforehand.

The material removed for influencing the unbalance of the workpiece W, in particular for at least partial circumferential reduction, in particular circumferential configuration of the workpiece W, can be removed from the workpiece, for example, in such a way that a flat point, a free-form surface or a circular sectional surface is formed on said workpiece.

The unbalance measuring device U separately can also be equipped with the data processing device DV, the processing means 6 for unbalance processing of the workpiece W, and the processing receptacle 5, comprising holding means 51, 53 for holding the workpiece W and the driving means 52 for setting the workpiece W into rotation.

A workpiece W, for example comprising a rotor shaft with shaft stubs Z or a rotor comprising a composite laminated core B and pressure disks D, as indicated in particular in FIG. 9, can be processed in the processing machine. The pressure disks D or the laminated core B are fastened to the rotor shaft. Bearing points L are formed on the shaft stubs Z, in particular the bearing points L are processed with high precision, in particular finished, in the processing machine.

In particular, regions X, which may be subject to processing, are provided on the workpiece W. For example, these regions X are on the shaft stub Z, on the shaft body itself, on the pressure disks D, or a combination thereof, as illustrated by way of example in the figures. In particular, one or more reference surfaces N extending at least partially over the circumference of the workpiece may be formed in said regions. These reference surfaces N may have one or more individual axial length(s), as a result of which the reference surfaces N may differ in size. In particular, a reference surface N is designed in such a way that it extends coaxially with respect to the processed bearing point L. Preferably, a concentricity error of the reference surface N with respect to the bearing point L is less than 15 μm, in particular less than 10 μm. The radial distance NR of the reference surfaces N from the rotational axis R and thus indirectly the distance from the bearing point L is preferably calculated by a computer program. The anticipated unbalance, the mass available for the balancing, i.e. the separable mass, in particular material of the workpiece W, and the preferred position of the region X, and thus of the surface N, are taken into consideration in the calculation. In addition, the selection of the processing means 6 also has to be taken into consideration, since, depending on the processing means 6, the possible processing direction and the space required for the processing along, in particular running radially around, the workpiece have to be taken into account. Thus, in the case of one workpiece W, for example a rotor shaft, a different processing means 6 than in the processing of a rotor, which already comprises a pressure disk D or a laminated core B, can be used.

Furthermore, the processing means 6 is preferably illustrated in the figures in such a way that the impression may arise that radially directed processing is carried out, in particular the processing means 6 is moved in the radial direction to the workpiece W. This is particularly the case if the processing means 6 is a grinding wheel or a belt abrasive, or a combination thereof. However, said processing means 6 may also be moved to the workpiece from the radial direction, in particular from the direction deviating from the vertical, for the processing.

As described above, other processing means 6, the main processing direction of which, for example, may be axially along the rotational axis R of the workpiece W, can also be provided or at least additionally used. Depending on the processing means 6 used, in particular the surface running orthogonally to the rotational axis R can also be formed with high precision relative to the bearing point L and also constitutes a possible reference surface. Here, however, especially in their angular position or orthogonal course.

In the case of the finished, i.e. the balanced, workpiece W or in the case of the workpiece W where the unbalance is reduced, at least one of the reference surfaces N is processed, for example changed, partially, in particular in sections, as a result of which the distance of the newly formed surface radially in the direction of the rotational axis R from the previously formed surface running coaxially with respect to the bearing point L is reduced.

The position of the reference surface N on the workpiece W is defined before the processing, for example ascertained with the aid of a computer program. The precisely formed reference surface N is then the reference surface for further, in particular subsequent, processing of the workpiece W, for example for the balancing of the workpiece W. Starting from this defined reference surface N, in particular with high coaxial accuracy with respect to the bearing point L, the material having to be removed from the workpiece W for balancing purposes or for reducing the unbalance can be calculated more accurately and can ultimately also be removed more accurately. With the improved determination of the material to be removed, in particular with the more precise and more accurate removal of the material, the balancing grade, in particular the balancing quality, increases.

If the reference surface N is not formed, the position on the workpiece W and the quantity of material actually removed during the processing are subject to strong fluctuations. For example, tolerances in the production process of the workpiece, such as kneading, welding, casting or else the components for the multi-part rotor shaft or else the joined rotor, are subject to certain tolerances and process fluctuations. For example, the accuracy during the joining or the laminated core B per se and, if necessary, the pressure disks D can thus also have a significant influence on the unbalance of the rotor. The targeted removal of material on the workpiece W can then lead to corresponding fluctuations in the results when reducing the unbalance. This is where the idea of the reference surface N, which is arranged coaxially with respect to the bearing point L, comes into play, by means of which a more precise removal of material and thus balance quality can be achieved.

For example, a basis for the reference surface N can be made in an upstream step or in the production of the workpiece W. In a downstream step, an improved, in particular the correct and highly accurate reference surface N can then be made in a mounting set-up with the processing of the bearing points L.

FIG. 11 schematically illustrates processing of the workpiece W, in particular the bearing points on the rotor shaft. For this purpose, the processing means 6, for example a grinding device, is used. A bezel or the like is also possible for absorbing and/or supporting grinding forces. A dashed line indicates a different processing situation or a different tool.

In this other processing situation, at least one reference surface N can be formed in the region X of the workpiece. The reference surface N is preferably arranged in such a way that it extends coaxially with respect to the bearing point L. If the workpiece is a rotor shaft or a rotor, the region X in which the reference surface N is formed at least in sections can comprise the shaft stub Z, the shaft body or the pressure disk D, wherein the region X does not comprise the bearing point L, the seat of the laminated core B or the seat of the pressure disks D. These reference surfaces N can be formed very accurately, especially with a low concentricity error relative to the bearing point L. Preferably, the concentricity error is less than 15 μm, in particular less than 10 μm, relative to the bearing point L.

In the processing shown in FIG. 11, the workpiece W is received by means of the processing receptacle 5, in particular the holding means 51, 53. The processing receptacle 5, in particular the holding means 51, 53, can receive the workpiece, for example a rotor or a rotor shaft, on the rotational axis R or at least in the vicinity thereto. During the processing of the shaft stubs and the precise formation of the bearing points L, the workpiece W rotates about the rotational axis R.

In the same or unchanged mounting set-up by the processing receptacle 5, in particular of the holding means 51, 53, the reference surface N is formed in one processing step, in particular at least in part of the region X of the workpiece W with the processing means 6, by the removal of material from the workpiece. The reference surface N extends with a length NA coaxially with respect to the bearing point L, in particular with respect to the rotational axis R, and is in particular formed at least on part of the workpiece circumference. Owing to the unchanged mounting set-up when forming the reference surface N and the bearing point L, the concentricity error between reference surface N and bearing point L can be very low, preferably less than 15 μm, in particular less than 10 μm.

In the processing step shown in FIG. 14, for the balancing, in particular for reducing the unbalance, of the workpiece W, material can also be removed, starting from the reference surface N, by means of the processing means 6. The amount or position of the material to be removed in the process can be calculated by a data processing device DV on the basis of the data obtained regarding vibrations, in particular unbalance of the workpiece W on the balance measuring machine. The processing with the processing means 6 and rotation of the workpiece W may overlap.

FIG. 15 shows part of a workpiece W. The workpiece W shown is, for example, a rotor, i.e. the pressure disk D and the laminated core can be joined. Further processing has not yet been carried out, with a planned bearing point L on the shaft stub Z and also the region X in which the reference surface N can be formed being shown.

FIG. 16 illustrates in detail the section of the workpiece part indicated by an oval ring in FIG. 15, the situation here being during or after a first processing. In the case previously shown in FIGS. 10 to 14, this could correspond to the situation according to FIG. 11. The bearing point L on the shaft stub Z and reference surfaces N on the rotor shaft and on the pressure disk D are processed, in particular formed. The reference surfaces N extending at least partially over the circumference of the workpiece W each have a radius with respect to the rotational axis R, wherein RN1 indicates the radius with respect to the reference surface on the rotor shaft and RN2 the radius or the distance from the reference surface N on the pressure disk D. The axial length or the axial extent NA of the reference surface N along the rotational axis R of the workpiece W is also shown.

FIG. 17 shows the section indicated by an oval ring according to FIGS. 15 and/or 16, the situation after the processing of the workpiece W being shown here. During the balancing, material is removed from the workpiece, starting from the reference surface N. In particular, the amount and the position of the material to be removed is determined by the data processing system. Preferably, beforehand, the anticipated unbalance, and the location and amount of the material to be removed in each case, are simulated by a computer program or determined by calculation. It is advantageously then only necessary to form the reference surfaces N at the resultantly defined points on the workpiece W, which saves time and costs.

As furthermore shown in FIG. 17, the reference surface N may nevertheless be larger than required by the material to be removed. For example, here the axial extent NA of the reference surface N is greater than the axial extent of the removed material, as the remaining portion of the reference surface N formed in the pressure disk at the distance RN2 from the rotational axis R shows. In the case of the reference surface N formed in the rotor shaft, on the other hand, the entire axial extent NA has been used for the removal or the processing, wherein the same amount of material was not removed over the axial extent. This is clearly illustrated in particular by the gradation along the extent NA.

FIG. 18b illustrates a larger part of the workpiece W, including the section according to FIG. 17 with details of the workpiece. FIG. 18a shows a side view of the workpiece W, wherein the body edges resulting from the first processing operation, that is, from the forming of the reference surface N, can be seen; for example, the dashed-line circle with the radius RN2 to the rotational axis R, shown on the end face of the workpiece, pressure disk D with reference surface N. Furthermore, the material removal carried out during the balancing can be seen, wherein the removal of the material can lead to a flat point or to a circular arc or a free-form surface on the workpiece. In particular, the data processing system DV and the selected processing means are crucial here.

FIG. 19 shows, by way of example, that the workpiece W may also be a rotor comprising an assembled rotor shaft. The assembled rotor shaft comprises, for example, a flange F with the shaft stub Z formed thereon and the bearing point L and also a tube Ro pressed onto the flange F. The complete rotor comprises, for example, the assembled rotor shaft and the laminated core B and pressure disks D. By way of example, the reference surface N is formed here on the flange F. As the sectional illustration in particular furthermore shows, the reference surface does not extend over the entire circumference of the workpiece W. The reference surface N has an axial extent NA.

FIG. 20 shows an alternative configuration of the workpiece W. This configuration is used in particular when more material has to be removed for the balancing or for reducing the unbalance and thus for achieving the desired balance quality. The rotationally symmetrical workpiece W, such as a rotor shaft of an electric machine, is similar to the rotor shaft illustrated in FIG. 9. In particular, the rotor shaft W with end-side journals Z, and the laminated core B, illustrated by dashed lines, and the pressure disks D, illustrated by dotted lines, are shown. The pressure disks D or the laminated core B are fastened to the rotor shaft. Bearing points L are formed on the shaft stubs Z, in particular the bearing points L are processed with high precision, in particular finished, in the processing machine. In contrast to the workpiece according to FIG. 9, balancing disks WS are arranged or formed on the shaft stubs Z. Said balancing disks WS provide additional material for the balancing or for reducing the unbalance.

Integrally with the shaft stub Z should be understood as meaning that the balancing disk is formed with the shaft stub Z during or with the production thereof, by, for example, kneading, compression or casting. Alternatively, the balancing disk WS can be arranged or mounted on the shaft stub Z, as the right balancing disk is intended to illustrate in principle. For this purpose, the balancing disk WS is, for example, a separately produced component, which is then fastened to the shaft stub Z in a force-fitting and/or form-fitting and/or integrally bonded manner by means of known shaft-hub connections. In principle, it is also possible to install the balancing disk WS, which would create an assembled pressure disk with a balancing disk region.

In particular, regions X, which may be subject to processing, are provided on the workpiece W. For example, these regions X are on the balancing disk WS, which is arranged or formed on the shaft stub Z, on the pressure disks D, or on a combination thereof, as illustrated by way of example in FIGS. 20 and 21. No processing is provided on the shaft body itself, apart from in the bearing region L.

FIG. 21 shows a detail of a further preferred refinement of a workpiece W, in particular a rotor for an electric machine. The workpiece comprises a shaft with a shaft stub Z, a laminated core B and a pressure disk D. Processing is provided on the shaft stub Z to form the bearing point L; in addition, the pressure disk D and the balancing disk WS represent regions X provided for the processing.

FIG. 22 illustrates in detail the section of the workpiece part W indicated by an oval ring in FIG. 21, the situation here being during or after a first processing. In the method shown and described previously by FIGS. 10 to 14, this could correspond to the situation according to FIG. 11, wherein here additionally the balancing disk WS is present and has been processed. The bearing point L on the shaft stub Z and reference surfaces N on the balancing disk WS and on the pressure disk D are processed, in particular formed. The reference surfaces N extending at least partially over the circumference of the workpiece W each have a radius with respect to the rotational axis R, wherein RN1 indicates the radius with respect to the reference surface on the rotor shaft and RN2 the radius or the distance from the reference surface N on the pressure disk D. The axial length or the axial extent NA of the reference surface N along the rotational axis R of the workpiece W is also shown.

In particular, a reference surface N is designed in such a way that it extends coaxially with respect to the processed bearing point L. Preferably, a concentricity error of the reference surface N with respect to the bearing point L is less than 15 μm, in particular less than 10 μm. The radial distance NR of the reference surfaces N from the rotational axis R and thus indirectly the distance from the bearing point L is preferably calculated by a computer program. The anticipated unbalance, the mass available for the balancing, i.e. the separable mass, in particular material of the workpiece W, and the preferred position of the region X, and thus of the surface N, are taken into consideration in the calculation. In addition, the selection of the processing means 6 also has to be taken into consideration, since, depending on the processing means 6, the possible processing direction and the space required for the processing along, in particular running radially around, the workpiece have to be taken into account. Thus, in the case of one workpiece W, for example a rotor shaft, a different processing means 6 than in the processing of a rotor, which already comprises a pressure disk D or a laminated core B, can be used.

FIG. 23 shows the detail according to FIG. 22, the situation after the processing of the workpiece W being shown here. During the balancing, starting from the reference surface N, material is removed from the workpiece W, i.e., for example, from the balancing disk WS and/or the pressure disk D. In particular, the amount and the position of the material to be removed is determined by the data processing system. Preferably, beforehand, the anticipated unbalance, and the location and amount of the material to be removed in each case, are simulated by a computer program or determined by calculation. It is advantageously then only necessary to form the reference surfaces N at the resultantly defined points on the workpiece W, which saves time and costs.

As furthermore shown in FIG. 23, the reference surface N may nevertheless be larger than required by the material to be removed. For example, the axial extent NA of the reference surface N in the region of the pressure disk D is greater than the axial extent of the removed material, as the remaining portion of the reference surface N formed in the pressure disk D at the distance RN2 from the rotational axis R shows. In the case of the reference surface N formed in the balancing disk WS, on the other hand, the entire axial extent NA has been used for the removal or the processing, wherein the same amount of material was not removed over the axial extent. This is clearly illustrated in particular by the gradation along the extent NA.

FIG. 24 shows a preferred refinement of the workpiece W, wherein the workpiece W is designed, for example, as an assembled rotor. The assembled rotor shaft may comprise, for example, a flange F with the shaft stub Z formed thereon and a balancing disk WS fixed thereon, and also a tube Ro fixed on the flange F. The tube Ro can be fixed to, in particular pressed onto, the flange F by means of known force-fitting/form-fitting or integrally bonded connections. The complete rotor comprises, for example, the assembled rotor shaft and the laminated core B and the pressure disks D. In this refinement, the reference surface N is also concentric with respect to the bearing point L. The material removal for the balancing or for reducing the unbalance can be carried out as previously described, wherein the regions X to be processed of the workpiece W in this refinement are formed on the balancing disk WS or the pressure disk D. In principle, it is also possible to form or provide a region X to be processed on the laminated core B (not shown). The regions processed during the balancing do not necessarily have to extend over the entire circumference of the workpiece W, and therefore the material removal carried out during the balancing can lead to a flat point, to a circular arc and/or to a free-form surface on the workpiece W. In particular, the data processing system DV and the selected processing means are crucial here.

As already explained previously, the spring effect of the spring device 12, 22 can be achieved by means of mechanical, hydraulic or pneumatic components. FIG. 25 shows, for example, an unbalance measuring device U, in which a refinement of the leaf spring 121, the leaf spring arrangement 124, is shown. The leaf spring 121 is to be assigned to the mechanical spring devices. The spring effect or the spring behavior, such as the spring progression or the response behavior) of the leaf spring arrangement 124, is preferably by means of an adjustment device 24, the spring device 124 can adjustable in the spring behavior, such as the response behavior or the behavior over the spring travel. Owing to the adjustable spring behavior of the leaf spring arrangement, the unbalance measuring device U can be adapted to different workpieces W and/or to different unbalances and the measuring accuracy of the device can be improved. On the basis of the more accurate measurement data, the data processing system DV can determine the unbalance more accurately and can calculate the position of the material to be removed for the balancing. For further details regarding the device, reference is made to the previous explanations. For example, the quick-acting closure 7 can be actuated, i.e. opened or closed, automatically.

A damper 8 arranged between the connection device 11, 21 and the workpiece receptacle 13, 23 is designed in such a way to damp the vibrations of the workpiece receptacle 13, 23.

Preferably, the damping is adjustable in size, and therefore it can also be adapted to the anticipated unbalances of different workpieces W and the measurement result is not negatively affected. If the spring element is designed hydraulically or pneumatically, a damper can also preferably be realized therein.

FIG. 26 shows another device in which various refinements are illustrated together. Thus, the pivot arms 123, 223 are replaced by a spring device 12, 22 or a leaf spring arrangement 124. Furthermore, a damper 8 is arranged between the connection device 11, 21 and the workpiece receptacle 13, 23, the damper being designed to damp the vibrations of the workpiece receptacle 13, 23. Preferably, the damping is adjustable in size and depending on the deflection of the workpiece receptacle 13, 23, and therefore the damping can also be adapted to the anticipated unbalances of different workpieces W and the measurement result is not negatively affected.

The quick-acting closure 7 can be replaced, for example, by other measures or devices that can exert a force F7 on the workpiece W. It is also suitable for holding the workpiece W in the workpiece receptacle 13, 23 or for preventing the workpiece W from lifting off the rollers 131, 132, 231, 232.

Furthermore, a stop 9 is shown in FIG. 26, which stop is designed to limit the deflection of the tool receptacle 13, 23 relative to the connection device 11, 21. In a further preferred refinement, the stop 9 is adjustable by means of an actuating element 10.

With the adjustable spring device 121, 124, the adjustable damper 8 and the adjustable stop 9, individually or in combination, it is preferably possible to adjust the unbalance measuring device U to different workpieces W and to improve the measurement results. On the basis of the improved measurement results, the unbalance can then be eliminated with greater accuracy or at least more greatly reduced and the balance quality of the workpiece improved.

FIGS. 27a and 27b schematically illustrate the shaft stub Z of workpiece W with the holding device 51, 53. The situation shown here is similar in principle to the processing and measurement situations described in relation to and with FIGS. 10 to 14. FIG. 27a shows how the holding means 51, 53, for example, a truncated cone, is in engagement with the shaft stub Z or is retracted into the shaft stub Z. The driving means 52 is also in engagement with the workpiece W or with the shaft stub Z. This situation is found, for example, during the processing of the workpiece.

The forces occurring during the processing can be absorbed by the holding means 51, 53 and dissipated into the machine or the machine bed. The rollers 131, 132, 231, 232 do not lie against the workpiece or are still not in contact with the workpiece. For example, the driving means 52 engages on the workpiece W in a form-fitting manner. The driving means 52 brings the workpiece W to a predetermined speed, in particular to a processing speed or a balancing speed or a balancing speed range, at which different balancing speeds are traveled through. A plurality of speeds can be approached or traveled through, in particular braking as a negative acceleration is also possible. Owing to the form fit or on the basis of references on the workpiece, its relative angular position is known, which also makes it possible for defined angular positions to be set for processing the workpiece W. Preferably, material removal that does not run around the workpiece W is thus possible, as previously described.

A balancing speed can be understood as meaning a certain speed or a certain speed range to be traveled through, at which the workpiece rotates and preferably a measurement of the unbalance is carried out. This depends in particular on the component to be balanced and its subsequent operating speeds. For the angularly precise receiving of the workpiece W, the angular position of the workpiece W can preferably be determined via sensors and references formed/mounted on the workpiece W. Further preferably, the form-fitting engagement of the driving means 52 serves as a reference for determining the angular position of the workpiece W.

FIG. 27b schematically illustrates how holding means 51, 53 are no longer in engagement or in contact with the shaft stub Z or the workpiece W. In the method described previously, in particular by FIGS. 10 to 14, the decoupling of the holding means 51, 53 from the shaft stub Z and the receiving or the application of the rollers 131, 132 on or to the shaft stub Z can preferably be an overlapping movement. As a result, a rotational axis RH of the holding means 51, 53 and the rotational axis RW of the workpiece always run identically or virtually identically, on a rotational axis. The situation according to FIG. 27b differs in that the holding device 51, 53 is decoupled from the shaft stub Z, for example is moved to the left. As a result, the workpiece W is no longer guided on the rotational axis RH of the holding means 51, 53 and is lowered onto the rollers 131, 132. The rotational axes of holding means 51, 53 and of the workpiece W no longer run concentrically. The driving means 52 can still be in engagement here with the shaft stub Z in order to rotate the workpiece at balancing speed or to travel through a balancing speed range. The situation shown here can, for example, reflect the arrangement when measuring the unbalance. The driving means 52 is preferably designed such that the offset of the rotational axes RH and RW has no influence on the device or the workpiece W and thus on a possible unbalance measurement. For example, the driving means is in engagement with or coupled to the workpiece W by means of an Oldham coupling.

FIG. 27c shows in principle, like FIG. 27b, the parallel-displaced course of the rotational axes RH, RW of holding means and workpiece. Only here, the driving means 52 is not in engagement with the shaft stub Z. The situation shown in FIG. 27c can reflect a further preferred arrangement during the measurement of the unbalance.

So that the workpiece W takes up its axial position in the unbalance measuring device and can be decoupled or is not impermissibly displaced during the decoupling of the holding means 51, 53, an axial guiding force Fa should be in effect. The radial guiding force is realized, for example, by the holding elements 51, 53 and/or the rollers 131, 132. The holding means 51, 53 or the driving means 52 can also prevent, for example, lifting off of the workpiece W from the rollers 131, 132 or at least support here corresponding holding means, such as the quick-acting closure 7. For this purpose, the holding means 51, 53, for example, are not completely guided out of or away from the shaft stub Z.

After the unbalance has been measured, the holding means 51, 53 and optionally the driving means 52 can be brought back into engagement with the shaft stub Z, as shown in FIG. 27a. The angularly precise processing, i.e. the balancing, of the workpiece W can then take place. The angular position of the workpiece W can be determined, for example, by references on the workpiece. The references can be attached to or formed on the workpiece W. The form fit with respect to the driving means 52 can constitute such a reference.

FIGS. 28a to 28c schematically illustrate the shaft stub Z of workpiece W through the holding device 51, 53. The situation shown here is similar in principle to the processing and measurement situations described in relation to and with FIGS. 10 to 14 and with FIGS. 27a to 27c. FIG. 28a shows how the holding means 51, 53 is in engagement with the shaft stub Z or is retracted into the shaft stub Z. The holding means 51, 53, for example, is an expandable lining or truncated cone. By way of the expandable holding means 51, 53, the effective diameter can be changed via the expansion or non-expansion of clamping receptacles 61. The shaft stub Z can thus be clamped or not clamped depending on the expansion. The driving means 52 is also in engagement with the workpiece W or with the shaft stub Z. The rotational axis Rh of the holding means 51, 53 and the rotational axis of the workpiece W coincide or are congruent. This situation is found, for example, during the processing of the workpiece W.

The forces occurring during the processing can be absorbed by the holding means 51, 53 and dissipated into the machine or the machine bed. The rollers 131, 132, 231, 232 do not lie against the workpiece W or are still not in contact with the workpiece. For example, the driving means 52 engages on the workpiece W in a form-fitting manner. The driving means 52 brings the workpiece W to a predetermined speed, in particular to a processing speed or a balancing speed. Owing to the form fit or on the basis of references on the workpiece, its relative angular position is known, which also makes it possible for defined angular positions to be set for processing the workpiece W. For example, material removal that does not run around the workpiece W is thus possible, as previously described.

A balancing speed can be understood as meaning a certain speed or a certain speed range to be traveled through, at which the workpiece rotates and preferably a measurement of the unbalance is carried out. This depends in particular on the component to be balanced and its subsequent operating speeds. For the angularly precise receiving of the workpiece W, the angular position of the workpiece W can preferably be determined via sensors and references formed/mounted on the workpiece W. Further preferably, the form-fitting engagement of the driving means 52 serves as a reference for determining the angular position of the workpiece W.

FIG. 28b schematically illustrates how the holding means 51, 53 are no longer expanded, i.e. the workpiece W or the shaft stub Z is clamped. In the method described previously, in particular by FIGS. 10 to 14, the decoupling of the holding means 51, 53 from the shaft stub Z and the receiving or the application of the rollers 131, 132 on or to the shaft stub Z can preferably be an overlapping movement. As a result, a rotational axis RH of the holding means 51, 53 and the rotational axis RW of the workpiece W preferably always run identically or virtually identically. The situation according to FIG. 28b differs in that the expansion of the holding device 51, 53 and thus the clamping or the effective diameter are reduced. The shaft stub Z initially rests loosely on the holding means 51, 53 and is no longer clamped. The more the effective diameter is reduced, i.e. the expansion is reduced, the more the workpiece W shifts or lowers downward in the direction of rollers 131, 132, following gravity. From one point in time onward, the workpiece W rests on the rollers 131, 132 and is guided by them. The holding means 51, 53 then preferably no longer have any contact with the workpiece or shaft stub. The rotational axes of holding means 51, 53 and of the workpiece W no longer run concentrically. The driving means 52 can still be in engagement here with the shaft stub Z in order to rotate the workpiece at balancing speed or to travel through a balancing speed range. The situation shown here can, for example, reflect the arrangement when measuring the unbalance.

In principle, it is also possible for the expansion and thus the diameter of the holding means 51, 53 to be reduced only to the extent that the holding means 51, 53 no longer clamps the workpiece or the shaft stub Z, wherein the lowering of the workpiece W onto the rollers 131, 132 can be carried out by a downward movement of the holding means. The resulting situation is as illustrated in FIG. 28b, the rollers 131, 132 are in contact, and the holding means 51, 53 has no contact, with the workpiece W.

FIG. 28c shows in principle, like FIG. 28b, the parallel-displaced course of the rotational axes RH, RW of holding means and workpiece. Only here, the driving means 52 is not in engagement with the shaft stub Z. The situation shown in FIG. 27c can reflect a further preferred arrangement during the measurement of the unbalance. The holding means 51, 53 or the driving means 52 here can also prevent, for example, lifting off of the workpiece W from the rollers 131, 132 or at least support here corresponding holding means, such as the quick-acting closure 7. For this purpose, the holding means 51, 53, for example, are not completely guided out of or away from the shaft stub Z.

So that the workpiece W takes up its axial position in the unbalance measuring device and can be decoupled or is not impermissibly displaced during the decoupling of the holding means 51, 53, an axial guiding force Fa has to be in effect. The radial guiding force can be realized by the holding elements 51, 53 and/or the rollers 131, 132.

After the unbalance has been measured, the holding means 51, 53 can be expanded again (the workpiece W clamped) and, if necessary, the driving means 52 can be brought back into engagement with the shaft stub Z, as shown in FIG. 28a. The angularly precise processing, i.e. the balancing, of the workpiece W can then take place. The angular position of the workpiece W can be determined by references on the workpiece. The references can be attached to or formed on the workpiece W. The form fit of the workpiece W with respect to the driving means 52 can constitute such a reference.

1-26. (canceled)

27. An unbalance measuring device, comprising:
two spaced-apart workpiece receiving devices for rotatably receiving a workpiece, the unbalance of which is to be measured; and
at least one sensor for detecting a vibration of the workpiece during the rotation wherein the workpiece receiving devices each have a respective connection device for the positionally fixed fastening, and a respective workpiece receptacle for the rotational receiving of a workpiece portion, wherein a respective spring device is arranged between the connection devices and the workpiece receptacles.

28. The unbalance measuring device of claim 27, wherein the at least one sensor is attached to one of the workpiece receptacles.

29. The unbalance measuring device of claim 27, wherein the workpiece receptacles form a predetermined rotational axis (R) of the workpiece to be received.

30. The unbalance measuring device of claim 27, wherein the workpiece receiving devices each form a vertical axis (H1 or H2), wherein the vertical axes (H1 and H2) intersect the rotational axis (R) and are oriented at a right angle to the rotational axis (R).

31. The unbalance measuring device of claim 27, wherein the spring device is configured such that the connection device and the workpiece receptacle are displaced in relation to each other from a starting position, wherein the spring device is configured to move the workpiece receptacle into the starting position.

32. The unbalance measuring device of claim 27, wherein the spring device includes a leaf spring as a spring element, which is connected to the connection device and to the workpiece receptacle.

33. The unbalance measuring device of claim 27, wherein the workpiece receptacles are configured to be displaced in a movement direction component perpendicular to the rotational axis (R) and perpendicular to the vertical axis (H1 or H2) relative to the connection devices.

34. The unbalance measuring device of claim 27, wherein the spring device has at least two pivot arms, each pivot arm being hinged to the connection device and to the workpiece receptacle, wherein the joint axes of the pivot arms are arranged parallel to the rotational axis (R).

35. The unbalance measuring device of claim 27, wherein the workpiece receptacle is a roller stand and comprises two rotatably mounted rollers, which between them form the receptacle for a portion of the workpiece, wherein the axis of rotation of the rollers is aligned parallel to the rotational axis (R).

36. The unbalance measuring device of claim 27, wherein the unbalance measuring device includes a quick-acting closure for each of the workpiece receptacles.

37. The unbalance measuring device of claim 27, wherein the quick-acting closure comprises a pivotable bracket with a rotatable roller, wherein the pivot axis of the bracket and/or the axis of rotation of the roller is aligned in parallel to the rotational axis (R).

38. A processing device for a workpiece, comprising
a processing receptacle for receiving the workpiece, comprising a first holding means, a second holding means and a driving means, wherein the driving means is configured to set the workpiece into a rotation, wherein the holding means are designed for holding the workpiece;
at least one processing means for processing the workpiece; and
an unbalance measuring device of claim 27.

39. The processing device of claim 38, further comprising a processing table.

40. The processing device of claim 39, wherein the vertical axes (H1, H2) are aligned perpendicular to the processing table, wherein the movement direction of the workpiece receptacles or at least one component of the movement direction of the workpiece receptacles is aligned perpendicular to the vertical axes (H1, H2) and the rotational axis (R).

41. The processing device of claim 38, wherein the holding means form-fitting elements or the holding means comprise an Oldham coupling.

42. A method for processing and for balancing a workpiece with the processing device of claim 38, comprising:
receiving the workpiece by the holding means and coupling the driving means to the workpiece;
processing the workpiece with the processing means;
inserting the workpiece into the unbalance measuring device by feeding the workpiece through the holding means and/or feeding the workpiece to the unbalance measuring device and accelerating the workpiece to the balancing speed using the driving means;
removing the driving means and at least one holding means from the workpiece;
measuring the unbalance of the workpiece by means of the sensor and transmitting the measurement results to a data processing device (DV);
receiving the workpiece by the holding means and coupling the driving means to the workpiece;
unbalance processing of the workpiece on the basis of the calculations of the data processing device (DV).

43. A method for balancing a workpiece with the unbalance measuring device of claim 27, wherein the unbalance measuring device is equipped with a data processing device (DV), a processing means for unbalance processing of the workpiece, and a processing receptacle, comprising holding means for holding the workpiece and a driving means, for setting the workpiece into rotation, comprising:
inserting the workpiece into the unbalance measuring device by feeding the workpiece through the holding means and/or feeding the workpiece to the unbalance measuring device and accelerating the workpiece to the balancing speed using the driving means;
removing the driving means and at least one holding means from the workpiece;
measuring the unbalance of the workpiece by means of the sensor and transmitting the measurement results to a data processing device (DV);
receiving the workpiece by the holding means and coupling the driving means to the workpiece;
unbalance processing of the workpiece on the basis of the calculations of the data processing device (DV) by the processing means.

44. A method for processing and for balancing a workpiece with the processing device of claim 38, comprising:
receiving the workpiece by the holding means and coupling the driving means to the workpiece;
processing the workpiece with the processing means;
inserting the workpiece into the unbalance measuring device by feeding it through the holding means and/or feeding it to the unbalance measuring device and rotating the workpiece at the balancing speed or in a balancing speed range using the driving means;
removing at least one holding means, preferably both holding means, from the workpiece;
measuring the unbalance of the workpiece by means of the sensor and transmitting the measurement results to a data processing device (DV);
receiving the workpiece by the holding means;
unbalance processing of the workpiece on the basis of the calculations of the data processing device (DV), preferably by the processing means.

45. A workpiece comprising:
one or more reference surfaces (N) extending at least partially over the circumference of the workpiece, wherein the workpiece is configured to be the processing device of claim 38.

46. The workpiece of claim 45, further comprising at least one bearing point (L) to be processed, wherein a reference surface (N) is designed in such a way that it extends coaxially with respect to the processed bearing point (L).

47. The workpiece of claim 45, wherein the reference surface (N) is configured to constitute a reference surface for further, processing of the workpiece.

48. The workpiece of claim 45, wherein the reference surfaces (N) have one or more individual axial length(s), as a result of which the reference surfaces (N) can differ in size.

49. The workpiece of claim 45, wherein the concentricity error of the reference surface (N) with respect to the bearing point (L) is less than 15 μm, in particular less than 10 μm.

50. The workpiece of claim 45, wherein the radial distance (NR) of the reference surfaces (N) from the rotational axis (R) and thus indirectly the distance from the bearing point (L) is calculated by a computer program.

51. The workpiece of claim 45, wherein the reference surface (N) extends with a length (NA) coaxially with respect to the bearing point (L), in particular with respect to the rotational axis (R) of the workpiece, and in particular is formed at least on part of the workpiece circumference.

52. A method for producing the reference surface on a workpiece of claim 45, comprising:
formed the reference surface (N) is in one processing step with the processing means by the removal of material from the workpiece in the same or unchanged mounting set-up by the processing receptacle.
